(19) United States
(12) Patent Application Publication
(10) Pub. No.: US 2026/0169190 A1
(43) Pub. Date: Jun. 18, 2026

(54) MULTI-ZONE FLAT-OPTICS ARCHITECTURES, SYSTEMS AND METHODS

(71) Applicant: 2Pi Inc., Cambridge, MA (US)

(72) Inventors: Tian Gu, Acton, MA (US); Hanyu Zheng, Quincy, MA (US); Hung-I Lin, Cambridge, MA (US); Juejun Hu, Newton, MA (US); Xiaochen Sun, Chino Hills, CA (US); Padraic Burns, Boston, MA (US)

(73) Assignee: 2Pi Inc., Cambridge, MA (US)

(21) Appl. No.: 19/420,470

(22) Filed: Dec. 15, 2025

Related U.S. Application Data
(60) Provisional application No. 63/733,694, filed on Dec. 13, 2024.

(51) Int. Cl. G02B 1/00

(52) U.S. Cl. CPC G02B 1/002

(57) ABSTRACT

Flat optics systems, architectures, and methods that incorporate multi-zone design for enhanced performance and multifunctionality. The flat optics technology incorporates metasurfaces to leverage the pixelated, planar device architecture to integrate additional features such as beam shaping, modulation, testing, alignment, and adaptive functionality on a single platform, offering superior performance and small form factor. A disclosed multi-zone flat optical device includes multiple flat optics components such as metasurfaces formed on or in a substrate, forming primary and auxiliary functional zones, where the primary functional zone performs a primary optical function, and the primary functional zones are used for testing, alignment, calibration, recognition, etc. The multiple functional zones may be configured to operate under different incident light conditions including wavelength, incident angle, polarization, etc. so that the operation of the auxiliary functional zones does not interfere with the operation of the primary functional zone. Fabrication and assembling methods are also disclosed.

### BACKGROUND OF THE INVENTION

This invention relates to flat optics systems, architectures, and methods, and in particular, it relates to flat optics systems that incorporate a multi-zone design.

Conventional optical systems face several inherent challenges due to their design and fabrication processes: (1) Component-level fabrication and assembly: lenses in conventional optical systems are individually fabricated, assembled, and aligned. This piecemeal approach is labor-intensive and requires precise handling, leading to increased costs and production time. (2) Complex multi-lens systems: typical optical systems involve multiple lenses that must work together to achieve the desired optical function. However, these systems can only be fully tested for performance after all components are assembled. This makes it difficult to isolate issues or conduct intermediate testing, often requiring time-consuming adjustments and rework. (3) Limited post-assembly testing: once the optical system is integrated into a final product, such as a camera module, it cannot be easily tested or calibrated again without disassembly. This limitation complicates quality assurance and inline evaluation, and reduces the ability to identify and rectify defects, potentially affecting the overall performance and reliability of the product.

Optical metasurfaces, which are planar arrays of subwavelength nanoantennas designed for precise wavefront manipulation, have quickly become a transformative technology in the field of optics. These compact, flat optics offer significant improvements in performance while reducing the size, weight, power, and cost (SWaP-C) of optical systems. However, despite their potential, current meta-optics face several limitations: (1) Component-level substitution: most state-of-the-art meta-optics are designed to replace traditional optical components (e.g., lenses), without reformatting the overall optical system architecture. As a result, while the lenses themselves may be more compact, the overall system design—including assembly, alignment, and testing processes—remains largely unchanged and complex. (2) Limited system integration: the integration of meta-optics often follows the same conventional assembly methods used for traditional optics. This approach does not leverage the unique advantages of metasurfaces, such as their planar nature and multi-functionality, leading to missed opportunities for simplifying system design and reducing complexity. (3) Single functionality constraint: many current meta-optics typically offer only a single, fixed functionality. This limits their versatility, as they cannot adapt to different tasks or conditions, similar to traditional optics.

### SUMMARY OF THE INVENTION

This invention relates to innovative flat optics systems, architectures, and methods that incorporate multi-zone design for enhanced performance and multifunctionality. The flat optics technology according to embodiments of the invention may incorporate metasurfaces to leverage the pixelated, planar device architecture to integrate additional features such as beam shaping, modulation, testing, alignment, and adaptive functionality on a single platform, offering superior performance and a reduced form factor compared to conventional optics. These versatile metasurface solutions can be applied across a wide range of optical systems, including imaging, sensing, LiDAR, illumination, display, and advanced computing applications.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

In one aspect, the present invention provides a multi-zone flat optics device, which includes: a substrate; a first flat optics component formed on, in, or over the substrate to form a first functional zone, wherein the first functional zone is configured to manipulate incident light by altering its phase, amplitude, or polarization; and a second flat optics component formed on, in, or over the substrate to form a second functional zone, wherein the second functional zone is configured to manipulate incident light by altering its phase, amplitude, or polarization, wherein the second functional zone has a linear size less than a half of that of the first functional zone, and wherein the first functional zone is located in a center area of the substrate and the second functional zone is located in a peripheral area of the substrate.

In another aspect, the present invention provides a multi-zone flat optics device, which includes: a substrate; a first flat optics component formed on, in, or over the substrate to form a first functional zone, wherein the first functional zone is configured to manipulate incident light by altering its phase, amplitude, or polarization; and a second flat optics component formed on, in, or over the substrate to form a second functional zone, wherein the second functional zone is configured to manipulate incident light by altering its phase, amplitude, or polarization, wherein under incident light of a first wavelength range or a first incident angle range or a first polarization, the first functional zone is configured to provide primary optical function including diffraction, refraction, transmission, reflection, absorption, or coupling, while the second functional zone is non-functional, and under incident light of a second wavelength range different from the first wavelength range or a second incident angle range different from the first incident angle range or a second polarization different from the first polarization, the second functional zone is configured to provide an additional optical function including diffraction, refraction, transmission, reflection, absorption, or coupling, while the first functional zone is non-functional.

In another aspect, the present invention provides a multi-zone flat optics device, which includes: a substrate; one or more flat optics components formed on, in, or over the substrate to form one or more functional zones, wherein each of the one or more functional zones is configured to manipulate incident light by altering its phase, amplitude, or polarization; and a non-transmissive, absorptive, reflective or deflective flat optics component formed on, in, or over the substrate, covering all areas of the substrate not occupied by the one or more flat optics components, configured to block or divert light. The non-transmissive, absorptive, reflective or deflective flat optics component may also be a non-transmissive, absorptive, reflective or deflective coating.

In another aspect, the present invention provides a multi-zone flat optics device, which includes: a substrate; a first flat optics component formed on, in, or over the substrate to form a first functional zone, wherein the first functional zone is configured to manipulate incident light by altering its phase, amplitude, or polarization; and a second flat optics component formed on, in, or over the substrate to form a second functional zone, wherein the second functional zone is configured to manipulate incident light by altering its phase, amplitude, or polarization, wherein the second functional zone has a linear size less than a half of that of the first functional zone, wherein at least a portion of the second functional zone spatially overlaps a portion of the first functional zone, and wherein overlapping portions of the first and second functional zones are configured to perform different functions under different properties of incident light.

In another aspect, the present invention provides a wafer-level multi-zone flat optics device, which includes: a wafer-level substrate comprising a plurality of substrate units; a plurality of first flat optics component formed on, in, or over the substrate to form a plurality of first functional zones, wherein each of the plurality of first functional zones is located within a substrate unit and is configured to manipulate incident light by altering its phase, amplitude, or polarization; and a plurality of second flat optics component formed on, in, or over the substrate to form a plurality of second functional zones, wherein at least some of the plurality of second functional zones are located in scribe lanes between substrate units of the wafer-level substrate, and each of the plurality of second functional zones is configured to manipulate incident light by altering its phase, amplitude, or polarization.

In another aspect, the present invention provides a multi-zone flat optics device, which includes: a substrate; a first flat optics component formed on, in, or over the substrate to form a first functional zone, wherein the first functional zone is configured to manipulate incident light by altering its phase, amplitude, or polarization; a second flat optics component formed on, in, or over the substrate to form a second functional zone, wherein the second functional zone is configured to manipulate incident light by altering its phase, amplitude, or polarization; and a third flat optics component formed on, in, or over the substrate to form a third functional zone, wherein the second functional zone is configured to manipulate incident light by altering its phase, amplitude, or polarization, wherein the second functional zone is configured to direct incident light to the third functional zone, and the third functional zone is configured to redirect the light from the second functional zone to the first functional zone.

In another aspect, the present invention provides a method of fabricating a flat optics device, which includes: fabricating a multi-zone flat optics device, the device including: a substrate, a first flat optics component formed on, in, or over the substrate to form a first functional zone, and a second flat optics component formed on, in, or over the substrate to form a second functional zone, wherein each of the first and second functional zones is configured to control or manipulate incident light by altering its phase, amplitude, or polarization; testing the second functional zone by directing a test light upon it and measuring a resulting output light from it, and characterizing one or more properties of the second functional zone based on the measured output light; and analyzing one or more properties of the first functional zone based on the one or more properties of the second functional zone.

In another aspect, the present invention provides a method of fabricating a flat optics device, which includes: fabricating a multi-zone flat optics device, the device including: a substrate, a first flat optics component formed on, in, or over the substrate to form a first functional zone, and a second flat optics component formed on, in, or over the substrate to form a second functional zone, wherein each of the first and second functional zones is configured to control or manipulate incident light by altering its phase, amplitude, or polarization; measuring one or more characteristics of the second functional zone; and calibrating or modifying the multi-zone flat optics device based on the measured one or more characteristics of the second functional zone.

In another aspect, the present invention provides a method of fabricating a flat optics device assembly, which includes: fabricating a plurality of multi-zone flat optics devices, wherein each flat optics device includes: a substrate, a first flat optics component formed on, in, or over the substrate to form a first functional zone, and a second flat optics component formed on, in, or over the substrate to form a second functional zone, wherein each of the first and second functional zones is configured to control or manipulate incident light by altering its phase, amplitude, or polarization; and assembling the plurality of flat optics devices to form a flat optics device assembly while using the second functional zones of the plurality of flat optics devices to guide positioning of the plurality of flat optics devices.

Each aspect of the invention may include some or all of the following characteristics.

In some embodiments, each flat optics component is a metasurface comprising meta-atoms.

In some embodiments, each metasurface is configured to operate in a refractive, diffractive, transmissive, absorptive, reflective, or coupling mode; geometries of the meta-atoms include rectangular, cylindrical, pillars, ridges, crossings, freeform shapes, or combinations of different structures; arrangements of the meta-atoms are periodic, including square, rectangular, or hexagonal lattice, or aperiodic, including randomized arrangements or varying distances between meta-atoms; the meta-atoms are formed from the same or different materials; the meta-atoms are immersed in, covered by, embedded within, or encapsulated in another medium, and different regions of the flat optics have the same or different heights, thicknesses, or effective optical path lengths.

In some embodiments, the first functional zone and the second functional zone are formed on a common surface or different surfaces of the substrate.

In some embodiments, under incident light of a first wavelength range or a first incident angle range or a first polarization, the first functional zone is configured to provide primary optical functions including diffraction, refraction, transmission, reflection, absorption, or coupling, while the second functional zone is non-functional, and under incident light of a second wavelength range different from the first wavelength range or a second incident angle range different from the first incident angle range or a second polarization different from the first polarization, the second functional zone is configured to provide an additional optical function including diffraction, refraction, transmission, reflection, absorption, or coupling, while the first functional zone is non-functional.

In some embodiments, the second functional zone is configured to generate a test output that is correlated to one or more performance-related and/or fabrication-related parameters of the first functional zone.

In some embodiments, the multi-zone flat optics device further includes a third flat optics component formed on, in, or over the substrate to form a third functional zone, wherein the second functional zone is configured to direct incident light to the third functional zone, and the third functional zone is configured to redirect the light from the second functional zone to the first functional zone.

In some embodiments, when the first and second functional zones spatially overlap, at least some meta-atoms in the overlapping portions of the first and second functional zones implement a multiplexed phase profile that provides a first optical function under incident light of a first wavelength or a first polarization or a first incident angle and a second optical function under incident light of a second wavelength or a second polarization or a second incident angle.

It is to be understood that both the foregoing general description and the following detailed description are exemplary and explanatory and are intended to provide further explanation of the invention as claimed.

### BRIEF DESCRIPTION OF DRAWINGS

Embodiments of the present invention are describe with reference to the following figures.

FIGS. 1A-1F schematically illustrate multi-zone flat optics architectures. FIG. 1A is a top view of an exemplary architecture. FIG. 1B is a side view of an exemplary architecture. FIG. 1C is a side view of an exemplary architecture with FZs positioned on different sides of the substrate. FIG. 1D is a side view of an exemplary metasurface structure including arrays of meta-atoms forming the multiple zones. FIG. 1E shows an exemplary structure with a transmissive FZ2. FIG. 1F shows an exemplary structure with a reflective FZ2. Each functional zone modulates the incident light (e.g., focusing, diverging, deflection, splitting, or forming any intensity/phase patterns) and may be used for primary optics functions, reference lens characterization, alignment, calibration, recognition, etc.

FIGS. 2A and 2B schematically illustrate multi-zone flat optics architectures, where multiple FZs are optically coupled to collectively perform functions, which may be used for lens characterization, alignment, calibration, recognition, etc.

FIGS. 3A-3C schematically illustrate exemplary multi-zone flat optics architectures. FIG. 3A is a top view of an exemplary architecture. FIG. 3B is a side view of an exemplary architecture. FIG. 3C is a side view of an exemplary architecture with FZs positioned on different sides of the substrate.

FIGS. 4A-4D schematically illustrate multi-zone flat optics architecture with multiplexed functions, where different FZs may be partially or fully overlapping with each other and may provide multiplexed functions.

FIG. 5A schematically illustrates a multi-unit flat optics architecture that includes an array of multi-zone flat optics structures. FIG. 5B is a side view of an exemplary multi-unit flat optics structure.

FIG. 6 schematically illustrates multiple layers of multi-zone flat optics which are optically coupled to perform optical functions such as primary optics functions, reference lens characterization, alignment, calibration, recognition, etc.

FIGS. 7A-7D schematically illustrates a multi-zone flat optics architecture with multiplexed functions.

FIG. 8 schematically illustrates a fabrication and assembly process for a flat optics device or assembly.

### DETAILED DESCRIPTION OF THE INVENTION

Embodiments of the present invention provide a novel approach to metasurface optics that addresses the limitations of current systems. The novel metasurface architectures, methods, and applications leverage the unique pixelated, planar, and thin nature of metasurfaces to go beyond traditional single-function designs. By integrating multiple functional zones (FZs) into a single metasurface layer, the embodiments provide additional capabilities that enhance the overall optical system performance, including (but not limited to): (1) Integrated testing and calibration: the architecture includes dedicated functional zones on the primary optical component for in-situ testing and calibration. These units can serve as reference elements to evaluate the performance of primary optical functions (e.g., imaging, sensing) without requiring disassembly or complex system-level testing. This capability allows for quality assurance at various stages of production, from wafer-level testing to post-assembly verification. (2) Alignment and assembly simplification: the embodiments embed alignment features directly within the metasurface design, streamlining the assembly process. (3) Multi-functional capabilities: the metasurface architecture supports multiple, adaptive functions within a single optical element. By dynamically responding to different properties of incident light (e.g., wavelength, polarization, angle of incidence), the same metasurface can perform diverse tasks such as refraction, reflection, diffraction, absorption, or any light modulation functions. This multiplexed functionality reduces the need for separate optical components, simplifying system design and enhancing versatility. The FZs may also be positioned on different sides of the substrate or overlapping with each other. All the above features may be configured so they are only operational or visible under specific light conditions, so that they do not interfere with the function of the primary optics.

This approach allows flat optics to become integral parts of a cohesive, multi-functional system, instead of isolated components. This enables a new generation of compact, efficient, and adaptive devices that set a new standard for performance and flexibility in optical applications.

Embodiments of the present invention provide advanced flat optics architectures, systems and methods. Flat optics may generally refer to metasurfaces, multilayer metasurfaces, diffractive optical elements (DOEs), holographic optical elements (HOEs), wafer-level optics (WLO), micro-optics, hybrid optics (e.g., metasurface combined with other optical components), coatings, etc. One example is optical metasurfaces, which are engineered artificial media consisting of two-dimensional (2D) arrays of subwavelength structures known as meta-atoms. These meta-atoms are positioned on a substrate and can be fabricated from the same or different optical materials as the substrate. The meta-atoms are specifically designed to manipulate incident light by altering its phase, amplitude, and polarization. Their geometries may include, but not limited to, rectangular, cylindrical, pillars, ridges, crossings, freeform shapes, or combinations of different structures. The arrangement can be periodic (e.g., square, rectangular, hexagonal lattice) or aperiodic (randomized or varying distances between meta-atoms). They may be formed from the same or different materials and may be immersed in, covered by, embedded within, or encapsulated in another medium. Different regions of the flat optics may have different heights.

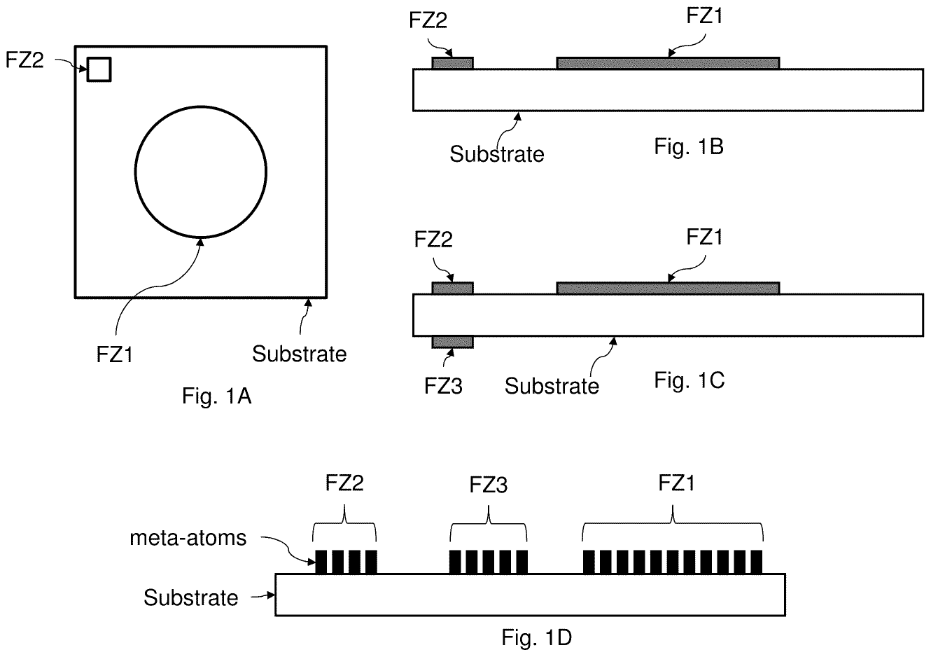

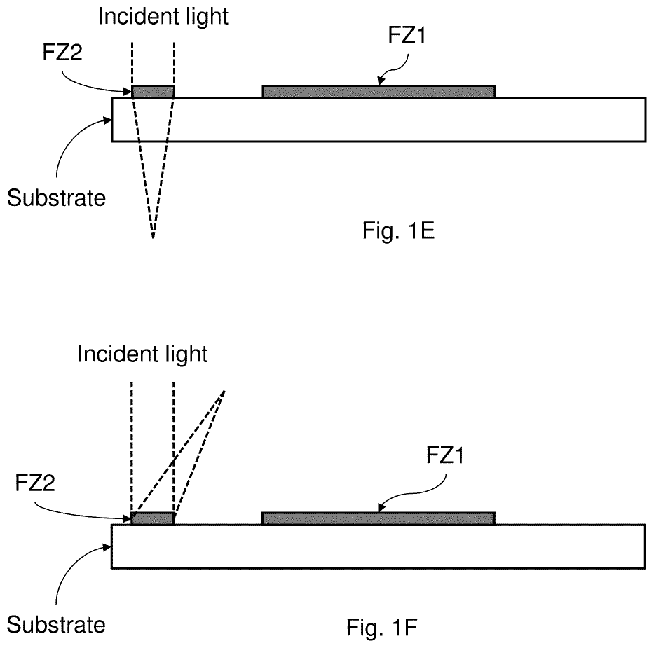

Embodiments of this invention provide a multi-zone flat optics device and architecture that integrate multiple functional zones (FZs) on a single substrate, an example of which is shown in FIGS. 1A-1F. The multi-zone flat optics device includes a substrate and multiple functional zones FZ1, FZ2, etc. formed on the substrate. The functional zones may be flat optics components that are configured to control or modulate the propagation of light. Each FZ may serve one or multiple optical functions or provide auxiliary capabilities, such as imaging, sensing, projection, alignment, testing, recognition, calibration, deflection, absorbing, etc. These FZs may fully or partially overlap, and multiple FZs may be embedded within each other. The same functional zone may possess multiple functions. The FZs may be formed on one or both sides of the substrate (see, e.g., FIGS. 1B and 1C respectively). The architecture is designed to be highly versatile, allowing integration of various functional zones within a compact, planar structure. FIG. 1D shows the sideview of an exemplary metasurface structure with arrays of meta-atom structures forming multiple FZs. The meta-atoms may be further immersed in or coated by another optical medium (e.g., air, polymer, dielectric, metal, coatings, etc.).

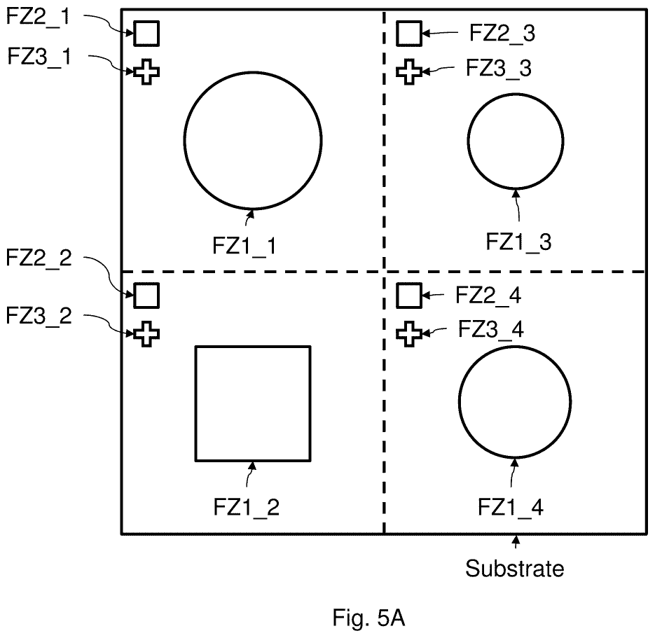

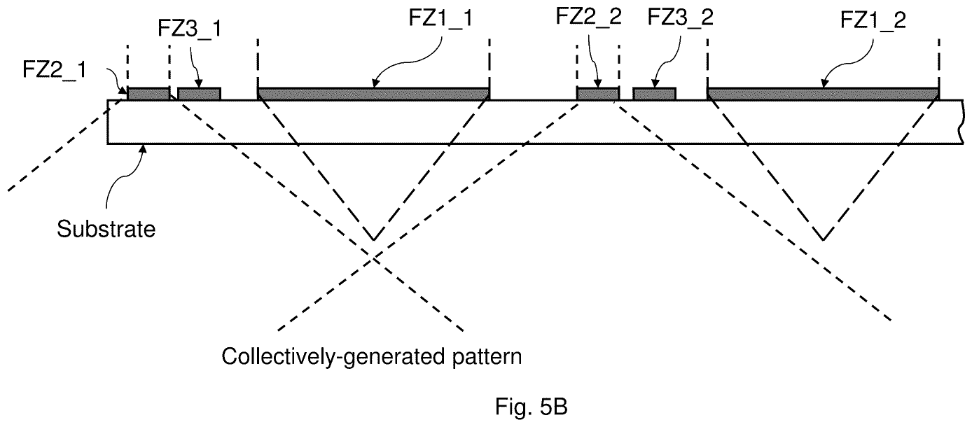

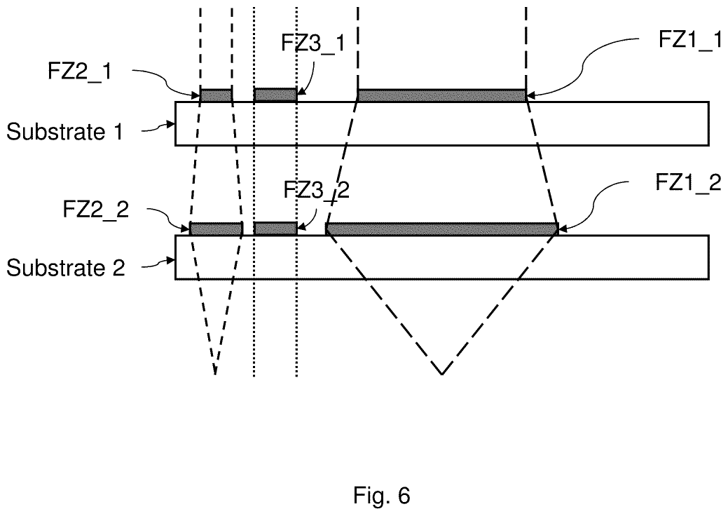

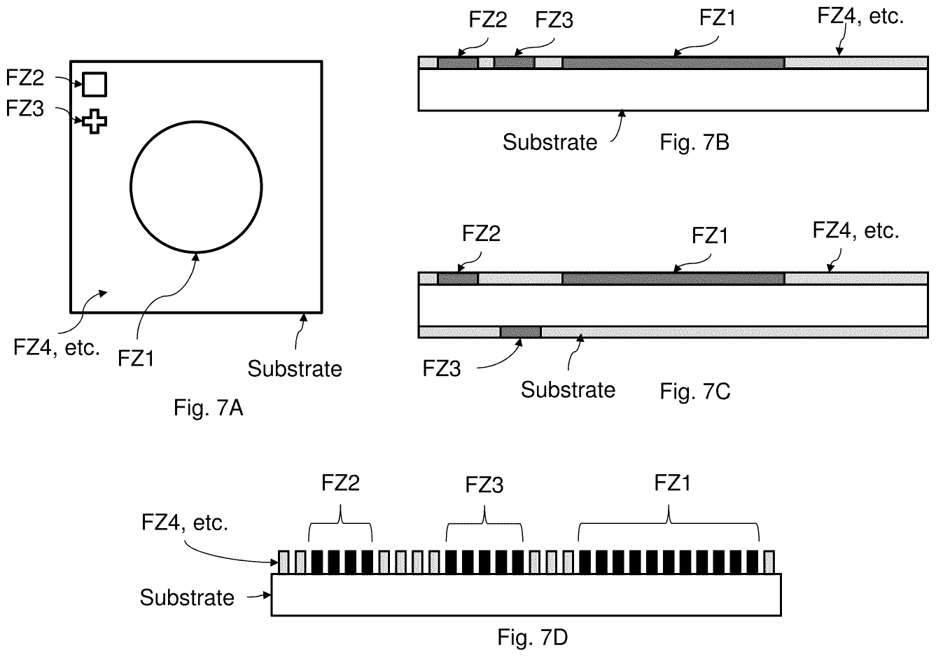

In one example, a first functional zone FZ1 provides the primary optical function (e.g., a metalens) and other (auxiliary) FZs may provide secondary functions. For example:
1. Testing: Dedicated FZs serve as reference elements, enabling pre-assembly testing without involving other optical components in the system or in-situ testing without requiring disassembly. For example, a second functional zone FZ2 may be a metalens used to evaluate the performance and functionality of FZ1. FZ2 may operate in refractive, diffractive, transmissive, absorptive, reflective, and/or coupling mode (e.g., FIGS. 1E and 1F, respectively showing a transmissive FZ2 and a reflective FZ2, where the dashed lines indicate exemplary light rays). For example, by forming FZ2 as a focusing lens/mirror, one can test it by directing a test light upon it and measuring the resulting output light from it, and characterize its focusing/imaging quality (e.g., efficiency, stray light, diffraction orders, point spread function, light intensity distribution, etc.) based on measurements of the output light. Such information can be used to analyze the performance of the primary optical element (e.g., FZ1) without directly testing the primary optical element using a test light. The second functional zone FZ2 may be constructed to make it easier to test, while the primary functional FZ1 zone must be designed to serve the primary optical functions and as a result may not lend itself to easy testing. For example, the primary functional zone FZ1 may be a lens having a focal length that makes is inconvenient for testing, or it may be a metasurface structure that does not by itself form an image; on the other hand, the second functional zone FZ2 may be made to have a focal length that is convenient for testing. In this regard, it should be note that the two functional zones FZ1 and FZ2 do not need to have the same metasurface structures, yet the testable properties of the second functional zone FZ2 can still be correlated to various performance-related and/or fabrication-related properties of the primary functional zone FZ1 such as optical efficiency, diffraction efficiency, coupling or mode matching efficiency, transmission, metasurface phase, amplitude and/or polarization profile, beam shaping or modulation functions, imaging quality, focal spot quality, beam steering angle, wavefront error/aberration signals, properties of different diffraction orders, stray-light level, wavelength, polarization, spatial, and/or angular dependent responses, material refractive index, etc., so that it can serve as a proxy. Other optical functions may also be employed. E.g., grating structures may also be utilized to study the properties of different diffraction orders. Multiple testing structures associated with different primary functional zones on the same substrate or from different substrates may be used collectively during testing (some examples are discussed in more detail later with reference to FIGS. 5A-B and 6).
2. Alignment: Some FZs may include alignment marks to aid in the alignment processes. Here, alignment refers to either the alignment steps during metasurface fabrication, or the optical alignment of multiple individual metasurface units in the lateral and/or vertical directions, or both. In some examples, the alignment marks may consist of patterned structures, or metasurface structures. Furthermore, such alignment marks may be visible only under specific light conditions (e.g., wavelength, polarization, incident angle, etc.), aiding precise assembly and reducing alignment complexity. For this purpose, the functional zone that serves as an alignment mark has a pre-defined spatial relationship on the substrate relative to the primary functional zone. Multiple alignment marks associated with different primary functional zones on the same substrate or from different substrates may be used collectively during alignment (some examples are discussed in more detail later with reference to FIGS. 5A-B and 6).
3. Recognition: Some FZs may incorporate patterns that become visible under incident light of specific wavelengths or polarizations, acting as unique identifiers, e.g., for information display, logo or anti-counterfeiting purposes.
4. Calibration: Arrays of nano-structures within a FZ can be used for analysis of meta-atom properties (e.g., geometry and/or optical constants), aiding calibration of the optical system. Calibration is an intermediate testing step to optimize the fabrication process, mainly focused on geometry correction (e.g., critical dimensions, pillar size, height, side-wall angle correction using SEM, TEM measurement), material characterization (e.g., refractive index, extinction coefficient), etc. For example, the FZ may contain arrays of all of the meta-atom (e.g., pillar) shapes available in a meta-atom library, which can then be tested or examined to evaluate their properties. Additional examples may include structures configured to examine one or a combination of the following: fabrication process bias and critical dimension/height bias; sidewall angle and etch depth uniformity; material refractive-index properties; pattern fidelity and stitching/overlay error; wavelength, polarization, spatial, and/or angular response; and/or uniformity quality across the substrate.
5. Blocking: Some FZs may be configured to block light. Such FZs may be used for optical apertures, windows, or to reduce stray light. In one example, all areas of the substrate not occupied by other functional zones are covered by a functional zone that blocks light (refer to FIG. 7A-7D, FZ4). This helps to block stray light and reduce noise. These FZs may be further configured to be functional only for light of specific wavelengths, polarization states and/or incident angles.
6. One FZ may further consist of multiple sub-zones or provide multiple functionalities.
7. Multiple FZs may work collectively to provide the desired functions. Some examples are discussed in more detail later with reference to FIGS. 5A-5B and 6.

The auxiliary functional zones that perform testing, alignment, recognition and calibration functions preferably have sizes substantially smaller than, e.g., less than a half of, or less than a quarter of, the size of the primary functional zone (note here that the drawings in this disclosure are not necessarily to scale). Here the “size” may be any suitable linear dimension such as radius, diameter, length, width, largest dimension, etc. Preferably, the primary functional zone is located in a center area of the substrate, while the auxiliary functional zones are located in a peripheral area of the substrate, e.g. near the edges or in the corners, so as not to interfere with the function of the primary functional zone.

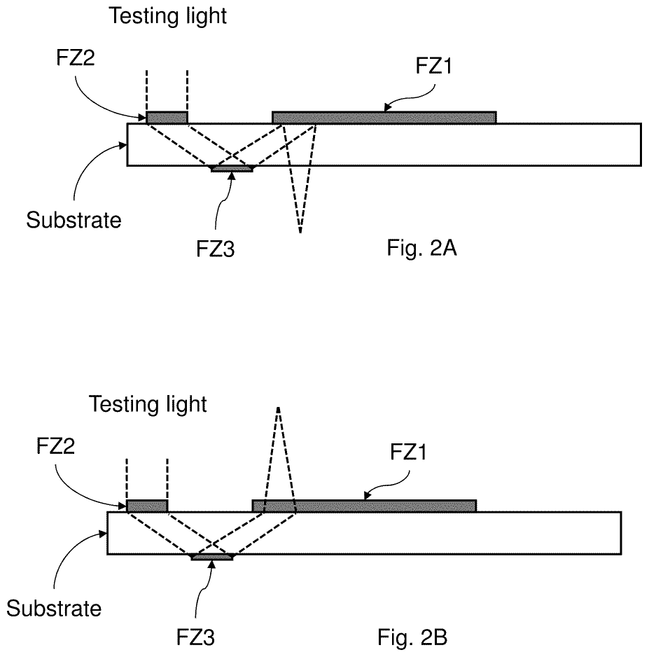

In another example, multiple FZs may be optically coupled. For example, as shown in FIGS. 2A and 2B, a second functional zone FZ2 couples light to a third functional zone FZ3 (a pattern unit or reflective surface) that reflects or re-direct/shapes the light toward the first functional zone FZ1. Then the testing beam interacts with FZ1 (fully or a portion). This method may be used to characterize the flat optics involved. In these examples, multiple FZs are optically coupled to collectively perform functions, which may be used for lens characterization, alignment, calibration, recognition, etc.

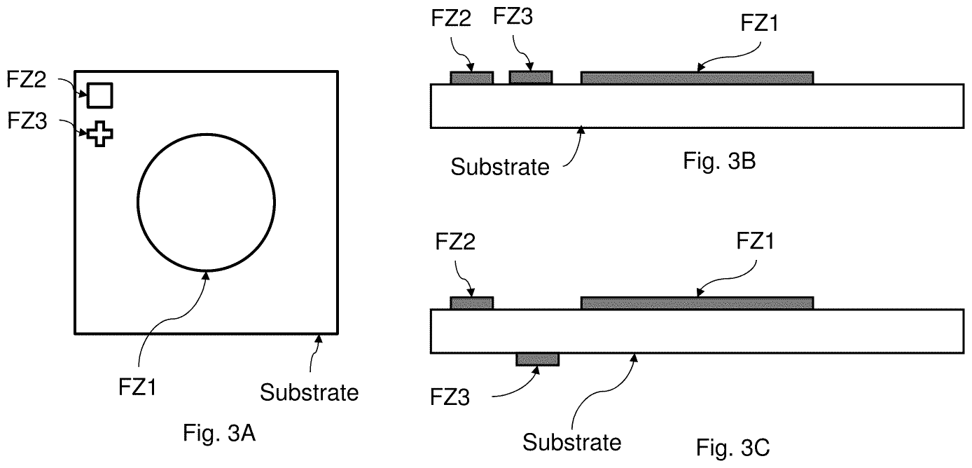

In one embodiment, shown in FIGS. 3A-3C, the multi-zone flat optics device includes a first functional zone FZ1 that functions as a primary optical element (e.g., a metalens), a second functional zone FZ2 that serves as a reference metasurface designed for testing or calibration, and a third functional zone FZ3 that includes alignment features for assisting fabrication and assembly (e.g., component integration or bonding). For example, FZ2 may be a metalens that serves as a reference device to analyze the performance of FZ1. FZ2 may also consist of arrays of nano-structures for pattern property analyses, e.g., morphology, optical constants, etc. FZ2 may operate in transmissive and/or reflective ways. It may be designed to be easily tested to analyze the optical performance of FZ1 instead of testing FZ1 or the entire optical system directly. This approach allows modular testing of individual FZs before full integration, improving yield and reducing the risk of defects. For example, FZ2 can be tested independently before the complete assembly, ensuring the performance of FZ1 without direct testing of the entire optical system. FZ1, FZ2 and/or FZ3 may be positioned on the same or different side of the substrate.

In yet another embodiment, the multi-zone flat optics include multiple FZs that respond differently to light based on its properties (e.g., wavelength, polarization, angle of incidence). For example: under a first wavelength range (or incident angle range, or specific polarization), FZ1 provides the primary optical function (e.g., diffraction, refraction, transmission, reflection, absorption, or coupling, etc.) while FZ2 is non-functional, so that FZ2 wouldn't affect the primary optical function of FZ1 under the first light property condition; under a second, different wavelength range (or incident angle range, or specific polarization), FZ2 is activated and provides additional functionalities (e.g., diffraction, refraction, transmission, reflection, absorption, or coupling, etc.) while FZ1 may be non-functional or may remain functional. This design allows dynamic switching of functions based on the incident light, enabling a single flat optics element to serve multiple roles.

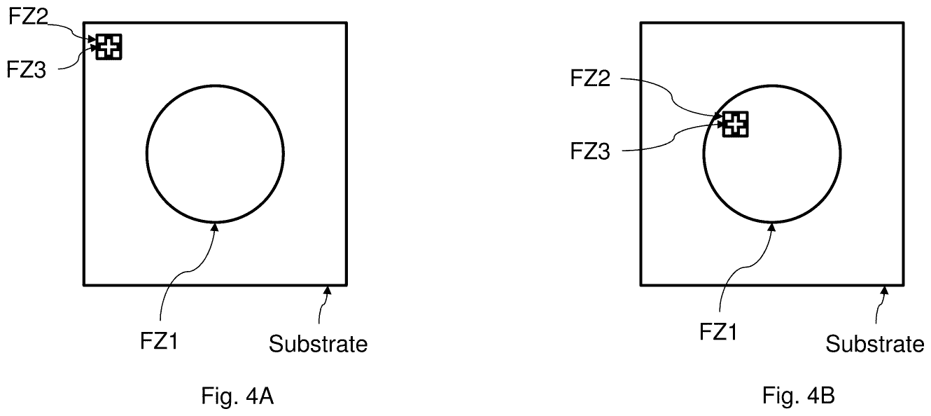

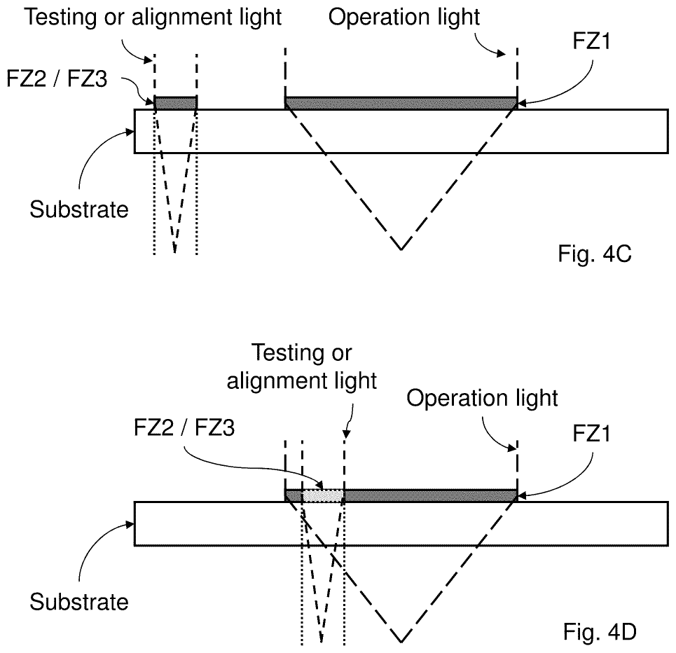

In one embodiment, shown in FIGS. 4A-4D, the flat optics architecture includes overlapping and multiplexed FZs. In this configuration, the FZs may be fully or partially overlapped in space, sharing the same or similar meta-atoms but providing different light modulation functions based on the properties of incident light (e.g., wavelength, polarization, incident angle, etc.). E.g., as depicted in FIGS. 4A and 4C, FZ1 is the primary optical element, and FZ2 and FZ3 provide additional functions. FZ2 and/or FZ3 may also be part of FZ1 with embedded multiplexed functions, as shown in FIGS. 4B and 4D. This approach allows for multiplexed functionalities, where: FZ1 performs primary optical tasks (e.g., imaging, sensing, projection, etc., as indicated by the long-dashed rays in FIGS. 4C and 4D); FZ2 acts as a reference component for performance testing/probing (as indicated by the short-dashed rays); FZ3 provides additional functions, such as alignment marks, or other optical functions, under different incident light conditions, as indicated by the dotted rays. Meanwhile, meta-atoms in FZ3 may provide the same function as meta-atoms in FZ2 under light with the same property so that it will not affect the function of FZ2 under FZ2's operation condition. Similarly, in the exemplary configuration depicted in FIG. 4D, meta-atoms in FZ2 and FZ3 may provide the same functions as meta-atoms in FZ1 under light with the same properties so that they will not affect the function of FZ1 under FZ1's operation condition, but will provide different functions than meta-atoms in FZ1 under light with different properties to perform their own designated functions.

The overlapping architecture enables efficient use of space on the metasurface, enhancing functionality without increasing size. By utilizing the same structures for multiple tasks, this embodiment maximizes the utility of the metasurface while minimizing complexity.

In a further embodiment shown in FIGS. 5A and 5B, multiple units of the multi-zone structures may be distributed on the same substrate or wafer. Each FZ may be configured to operate individually or collectively to modulate the incident light (e.g., focusing, diverging, deflection, splitting, or forming any intensity/phase patterns) and may be used for primary optics functions, reference lens characterization, alignment, calibration, recognition, etc. For example, multiple primary optics FZ1 elements (FZ1_1, FZ1_2, FZ1_3, etc.) may be included on the same substrate and they may have the same or different designs and functions. Each FZ1 element may be accompanied by FZ2 (FZ2_1, FZ2_2, FZ2_3, etc.) and FZ3 (FZ3_1, FZ3_2, FZ3_3, etc.). In one example, each FZ2 may be a reference metalens that can be used to analyze the performance of the corresponding FZ1. Each FZ2 may also consist of arrays of nano-structures for pattern property analyses, e.g., morphology, optical constants, etc. Each FZ3 may include alignment features. Multiple FZs may further partially or fully overlap with each other in the manners described earlier, and each FZ may provide multiplexed functions.

Multiple FZs (e.g., multiple FZ2s) may share the same design and function, enabling efficient, high-throughput, wafer-level testing. They may also be used to provide redundancy, ensuring consistent performance even if one unit experiences defects. Different functions may be assigned to different FZs (e.g., imaging, sensing, calibration, alignment, etc.), increasing the versatility of the metasurface. As shown in FIG. 5B, multiple FZs (multiple FZ2s in this example) may also work collectively (by generating certain intensity/phase patterns) to achieve certain functions, e.g., characterizing the optical performance of multiple regions, wafer level alignment, etc. In another embodiment, scribe lanes are formed between substrate units and some of the auxiliary functional zones FZ2s, FZ3s, etc. may be located in the scribe lanes.

In another example, multiple layers of the multi-zone flat optics may be stacked so that the FZs on different substrates may be optically coupled and perform functions collectively, as shown in FIG. 6. For example, each FZs may be configured to individually or collectively modulate the incident light. (e.g., focusing, diverging, deflection, splitting, or forming any intensity/phase patterns) and may be used for primary optics functions, reference lens characterization, alignment, calibration, recognition, etc. For example, in the illustrated examine, the second functional zone FZ2_1 on the first substrate and the second functional zone FZ2_2 on the second substrate collectively form a lens which may be used for testing; the third functional zone FZ3_1 on the first substrate and the third functional zone FZ3_2 on the second substrate may be used collectively for aligning the two substrates relative to each other. Multiple FZs may further partially or fully overlap with each other and each FZ may provide multiplexed functions. Spacers, apertures, filters, or any other optical components may be included this architecture.

Moreover, all the multi-zone architectures and functions described in the disclosure can further include additional FZs; or the entire remaining regions of the substrate may be covered by one or more FZs. For example, as shown in FIG. 7A, functional zones FZ1, FZ2, FZ3 etc., may be surrounded by another (a fourth) functional zone FZ4 consisting of meta-atoms, coatings, or other flat optics elements that modulate the light through, e.g., transmitting, reflecting, absorbing, deflection, diffraction, etc. It may be configured to act as a window, aperture, deflector, beam splitter, or serving any other suitable optical functions. FIGS. 7A-7C show exemplary architectures of this structure. FIG. 7D shows the sideview of an example metasurface structure with arrays of meta-atom structures forming multiple FZs. The meta-atoms may be further immersed in or coated by another optical medium (e.g., air, polymer, dielectric, metal, coatings, etc.). The multiple FZs may partially or fully overlap with each other, and each may provide multiplexed functions. As mentioned earlier, in one example, a functional zone (FZ4) is formed on the substrate to cover all areas that are not occupied by the other FZs and functions to block or divert light.

### Additional Information

In all embodiments of the present invention, the meta-atoms may have the same or different geometries, dimensions, and orientations. Exemplary geometries may include elliptical, rectangular, cylindrical, pillars, ridges, freeform, or any other suitable shapes or combinations of different shapes, etc. The lattice of the meta-atoms may have any suitable shape and period (e.g., square, rectangular, or hexagonal). The lattice may also be aperiodic, with varying or random distances between adjacent meta-atoms. In some examples, the gap between adjacent meta-atoms may be designed to have a constant gap distance.

Exemplary flat optics materials include, but are not limited to, dielectric materials (e.g., silicon, silicon nitride, titanium dioxide, niobium oxide, gallium nitride, chalcogenide glasses, etc.), polymers and organic materials (e.g., polymethyl methacrylate, polydimethylsiloxane, etc.), metals (e.g., gold, silver, aluminum, copper, etc.), semiconductors (e.g., silicon, silicon carbide, gallium arsenide, indium phosphide, etc.), transparent conducting oxides (e.g., indium tin oxide, fluorine-dope tin oxide, etc.), phase change materials (e.g., vanadium oxide, germanium antimony tellurium related alloys, etc.), two dimensional materials (e.g., graphene, molybdenum disulfide, etc.), ceramics (e.g., barium titanate, zirconia, etc.), coatings, metamaterials, etc. Exemplary substrate materials include, but are not limited to, silicon, glass, sapphire, polymers, quartz, alumina, polyimide, polyethylene terephthalate, ceramics, semiconductors, etc. The flat optics and substrate may be made of the same or different materials.

The flat optics described in this disclosure may be configured to operate at a wide range of wavelengths (e.g., from the visible to the infrared (IR)). The flat optics may be designed to operate at a single wavelength, multiple wavelengths, or over a continuous spectral range. In some examples, a flat optics can be designed to operate at any wavelength from the microwave to ultraviolet (UV) regions of the electromagnetic spectrum, with a bandwidth that spans up to an octave.

The flat optics may be formed on, in, or over the substrate. The flat optics may be flat, curved or conformally integrated with the substrate. One or both sides of the substrate may be flat or curved. Both the flat optics and the substrate may be rigid, flexible, or stretchable.

### Fabrication and Assembly Processes for Multi-Zone Flat Optics

The fabrication and assembly processes for multi-zone flat optics leverage advanced micro-and nanofabrication techniques, wafer-level processing, and streamlined assembly methodologies. These processes are designed to simplify production while enhancing precision, scalability, and performance.

Each individual flat optics device may be fabricated using any suitable fabrication process. The metasurface structures may be patterned using methods such as lithography (e.g., electron beam lithography, photolithography, nanoimprint lithography, focused-ion-beam lithography, gray-scale lithography, etc.), replication (e.g., molding, casting, embossing, etc.), laser direct writing, machining, etc. In some approaches, the patterns can be transferred to another material via etching or lift-off. To enhance durability and optical performance, the metasurface structures may be coated with additional layers or encapsulated in materials such as polymers, dielectric, metal, etc. The entire process can be performed at the wafer level, enabling high-throughput manufacturing of multiple functional zones on a single substrate.

The assembly process focuses on minimizing complexity and ensuring precise alignment of the fabricated metasurfaces. The alignment features (marks) described in the various embodiments can be used to guide the positioning of functional zones or different substrates/wafers with high accuracy. For example, when assembling multiple flat optics devices into a vertical stack, alignment features on different substrates may be optically coupled to generate certain patterns during the assembly process to provide enhanced precision or reduce alignment time. For example, such patterns may be designed to be sensitive to misalignment or easily accessible to the alignment tools, e.g., by increasing the depth-of-focus of the alignment beam or generating multiple patterns. Bonding is performed using adhesives, thermal bonding, or direct wafer bonding, creating a compact, multi-layered optical element. If the design incorporates hybrid optics, such as conventional lenses or additional coatings, these components can also be integrated during assembly.

The testing zones for in-situ performance verification/calibration can be utilized as an important step during assembly. These zones, either working individually or collectively across multiple zones or substrates, enable real-time assessment of optical functionality, alignment accuracy, and structural integrity without requiring disassembly or dedicated testing setups. For designs involving multiple layers of flat optics, modular assembly methods may be employed. Each layer is independently fabricated, tested, and then stacked with precise alignment maintained using spacers or alignment aids. Wafer-level assembly and testing are also utilized for large-scale production, where the entire wafer containing multiple flat optics units is processed and tested before being diced into individual devices.

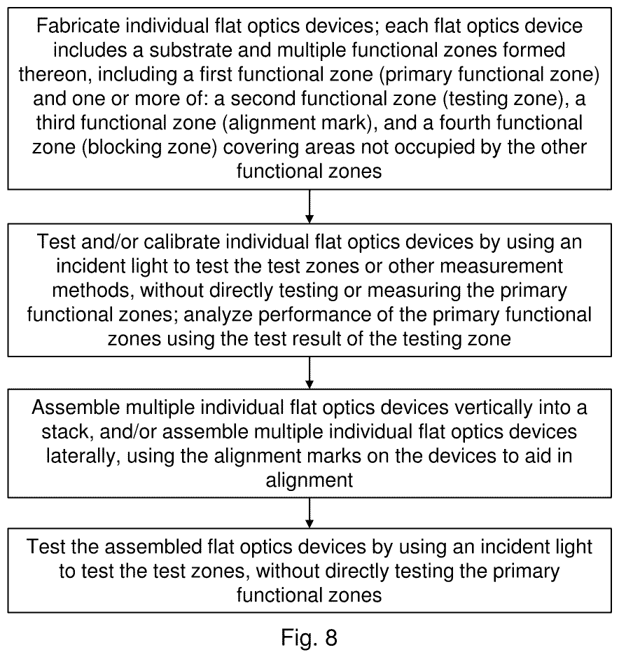

The fabrication and assembly process for the flat optics device or assembly is summarized in FIG. 8. It should be noted that not all steps summarized therein are required in every fabrication and assembly process. For example, some process may utilize the testing features without using the alignment features, or vice versa, etc.

These processes offer several key advantages. Wafer-level fabrication and testing enable scalable, high-throughput production. The use of flat-optics-enabled alignment features ensures improved precision and reduced alignment time, while modular testing and simplified assembly reduce overall manufacturing time and costs. Furthermore, in-situ and post-assembly testing improve reliability by enhancing quality control and minimizing defect rates.

This approach to fabrication and assembly highlights the innovation and practicality of the multi-zone flat optics technology, making it a transformative solution in the field of advanced optics.

It will be apparent to those skilled in the art that various modification and variations can be made in the multi-zone flat-optics architectures, systems and methods of the present invention without departing from the spirit or scope of the invention. Thus, it is intended that the present invention cover modifications and variations that come within the scope of the appended claims and their equivalents.

1. A multi-zone flat optics device, comprising:
a substrate;
a first flat optics component formed on, in, or over the substrate to form a first functional zone, wherein the first functional zone is configured to manipulate incident light by altering its phase, amplitude, or polarization; and
a second flat optics component formed on, in, or over the substrate to form a second functional zone, wherein the second functional zone is configured to manipulate incident light by altering its phase, amplitude, or polarization,
wherein the second functional zone has a linear size less than a half of that of the first functional zone, and wherein the first functional zone is located in a center area of the substrate and the second functional zone is located in a peripheral area of the substrate.

2. The multi-zone flat optics device of claim 1, wherein each flat optics component is a metasurface comprising meta-atoms.

3. The multi-zone flat optics device of claim 2,
wherein each metasurface is configured to operate in a refractive, diffractive, transmissive, absorptive, reflective, or coupling mode;
wherein geometries of the meta-atoms include rectangular, cylindrical, pillars, ridges, crossings, freeform shapes, or combinations of different structures,
wherein arrangements of the meta-atoms are periodic, including square, rectangular, or hexagonal lattice, or aperiodic, including randomized arrangements or varying distances between meta-atoms,
wherein the meta-atoms are formed from the same or different materials,
wherein the meta-atoms are immersed in, covered by, embedded within, or encapsulated in another medium, and
wherein different regions of the flat optics have the same or different heights, thicknesses, or effective optical path lengths.

4. The multi-zone flat optics device of claim 1, wherein the first functional zone and the second functional zone are formed on a common surface or different surfaces of the substrate.

5. The multi-zone flat optics device of claim 1, wherein under incident light of a first wavelength range or a first incident angle range or a first polarization, the first functional zone is configured to provide primary optical functions including diffraction, refraction, transmission, reflection, absorption, or coupling, while the second functional zone is non-functional, and under incident light of a second wavelength range different from the first wavelength range or a second incident angle range different from the first incident angle range or a second polarization different from the first polarization, the second functional zone is configured to provide an additional optical function including diffraction, refraction, transmission, reflection, absorption, or coupling, while the first functional zone is non-functional.

6. The multi-zone flat optics device of claim 1, wherein the second functional zone is configured to generate a test output that is correlated to one or more performance-related and/or fabrication-related parameters of the first functional zone.

7. The multi-zone flat optics device of claim 1, further comprising a third flat optics component formed on, in, or over the substrate to form a third functional zone, wherein the second functional zone is configured to direct incident light to the third functional zone, and the third functional zone is configured to redirect the light from the second functional zone to the first functional zone.

8. A multi-zone flat optics device, comprising:
a substrate;
a first flat optics component formed on, in, or over the substrate to form a first functional zone, wherein the first functional zone is configured to manipulate incident light by altering its phase, amplitude, or polarization; and
a second flat optics component formed on, in, or over the substrate to form a second functional zone, wherein the second functional zone is configured to manipulate incident light by altering its phase, amplitude, or polarization,
wherein under incident light of a first wavelength range or a first incident angle range or a first polarization, the first functional zone is configured to provide primary optical function including diffraction, refraction, transmission, reflection, absorption, or coupling, while the second functional zone is non-functional, and under incident light of a second wavelength range different from the first wavelength range or a second incident angle range different from the first incident angle range or a second polarization different from the first polarization, the second functional zone is configured to provide an additional optical function including diffraction, refraction, transmission, reflection, absorption, or coupling, while the first functional zone is non-functional.

9. The multi-zone flat optics device of claim 8, wherein each flat optics component is a metasurface comprising meta-atoms.

10. The multi-zone flat optics device of claim 9,
wherein each metasurface is configured to operate in a refractive, diffractive, transmissive, reflective, absorptive, or coupling mode;
wherein geometries of the meta-atoms include rectangular, cylindrical, pillars, ridges, crossings, freeform shapes, or combinations of different structures,
wherein arrangements of the meta-atoms are periodic, including square, rectangular, or hexagonal lattice, or aperiodic, including randomized arrangements or varying distances between meta-atoms,
wherein the meta-atoms are formed from the same or different materials,
wherein the meta-atoms are immersed in, covered by, embedded within, or encapsulated in another medium, and
wherein different regions of the flat optics have the same or different heights, thicknesses, or effective optical path lengths.

11. The multi-zone flat optics device of claim 8, wherein the first functional zone and the second functional zone are formed on a common surface or different surfaces of the substrate.

12. The multi-zone flat optics device of claim 8, wherein the second functional zone is configured to generate a test output that is correlated to one or more performance-related and/or fabrication-related parameters of the first functional zone.

13. The multi-zone flat optics device of claim 8, further comprising a third flat optics component formed on, in, or over the substrate to form a third functional zone, wherein the second functional zone is configured to direct incident light to the third functional zone, and the third functional zone is configured to redirect the light from the second functional zone to the first functional zone.

14. A multi-zone flat optics device, comprising:
a substrate;
one or more flat optics components formed on, in, or over the substrate to form one or more functional zones, wherein each of the one or more functional zones is configured to manipulate incident light by altering its phase, amplitude, or polarization; and
a non-transmissive, absorptive, reflective or deflective flat optics component formed on, in, or over the substrate, covering all areas of the substrate not occupied by the one or more flat optics components, configured to block or divert light.

15. The multi-zone flat optics device of claim 14, wherein each flat optics component is a metasurface comprising meta-atoms.

16. The multi-zone flat optics device of claim 15,
wherein each metasurface is configured to operate in a refractive, diffractive transmissive, reflective, absorptive, or coupling mode;
wherein geometries of the meta-atoms include rectangular, cylindrical, pillars, ridges, crossings, freeform shapes, or combinations of different structures,
wherein arrangements of the meta-atoms are periodic, including square, rectangular, or hexagonal lattice, or aperiodic, including randomized arrangements or varying distances between meta-atoms,
wherein the meta-atoms are formed from the same or different materials,
wherein the meta-atoms are immersed in, covered by, embedded within, or encapsulated in another medium, and
wherein different regions of the flat optics have the same or different heights, thicknesses, or effective optical path lengths.

17. The multi-zone flat optics device of claim 14, wherein the one or more flat optics components and the non-transmissive, absorptive, reflective or deflective flat optics component formed on a common surface or different surfaces of the substrate.

18.-51. (canceled)
